(19) United States
(12) Patent Application Publication
(10) Pub. No.: US 2015/0003410 A1
(43) Pub. Date: Jan. 1, 2015

(54) INTER RADIO ACCESS TECHNOLOGY (IRAT) MEASUREMENT DURING TD-SCDMA HANDOVER

(71) Applicant: QUALCOMM Incorporated, San Diego, CA (US)

(72) Inventors: MING YANG, SAN DIEGO, CA (US); TOM CHIN, SAN DIEGO, CA (US); GUANGMING SHI, SAN DIEGO, CA (US)

(21) Appl. No.: 13/932,884

(22) Filed: Jul. 1, 2013

(51) Int. Cl. H04W 36/00

(52) U.S. Cl. CPC H04W 36/0055
USPC 370/331

(57) ABSTRACT

A user equipment improves handover performance by reusing stored inter-radio access technology (IRAT) measurement information associated with common GSM neighbor cells when a UE moves from a serving TD-SCDMA cell to a closely-located target TD-SCDMA cell. In one instance, the UE may be handed over from a first cell of a first radio access technology (RAT) to a second cell of the first RAT, in which the first and second cells are closely-located. In accordance with the handover, the UE may receive an inter-radio access technology (IRAT) measurement request from the second cell. The UE may reuse measurements of target cells in a second RAT that were measured when in the first cell.

### BACKGROUND

1 Field

Aspects of the present disclosure relate generally to wireless communication systems, and more particularly, to improving an Inter Radio Access Technology (IRAT) measurement during Time Division-Code Division Multiple Access (TD-CDMA) intra or inter frequency handover.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes handing over from a first cell of a first radio access technology (RAT) to a second cell of the first RAT, the first and second cells being closely-located. The method may also include receiving an inter-radio access technology (IRAT) measurement request from the second cell. The method may also include reusing measurements of target cells in a second RAT that were measured when in the first cell.

According to another aspect of the present disclosure, an apparatus for wireless communication includes means for handing over from a first cell of a first radio access technology (RAT) to a second cell of the first RAT, the first and second cells being closely-located. The apparatus may also include means for receiving an inter-radio access technology (IRAT) measurement request from the second cell. The apparatus may also include means for reusing measurements of target cells in a second RAT that were measured when in the first cell.

According to one aspect of the present disclosure, a computer program product for wireless communication in a wireless network includes a computer readable medium having non-transitory program code recorded thereon. The program code includes program code to hand over from a first cell of a first radio access technology (RAT) to a second cell of the first RAT, the first and second cells being closely-located. The program code also includes program code to receive an inter-radio access technology (IRAT) measurement request from the second cell. The program code also includes program code to reuse measurements of target cells in a second RAT that were measured when in the first cell.

According to one aspect of the present disclosure, an apparatus for wireless communication includes a memory and a processor(s) coupled to the memory. The processor(s) is configured to hand over from a first cell of a first radio access technology (RAT) to a second cell of the first RAT, the first and second cells being closely-located. The processor(s) is further configured to receive an inter-radio access technology (IRAT) measurement request from the second cell. The processor(s) is further configured to reuse measurements of target cells in a second RAT that were measured when in the first cell.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a GSM frame cycle.

FIG. 6 illustrates a call flow implementation for handing over a UE from a serving TD-SCDMA cell to a closely-located target TD-SCDMA cell according to some aspects of the present disclosure.

FIG. 7 is a block diagram illustrating a method for improving Inter Radio Access Technology (IRAT) during Time Division-Code Division Multiple Access (TD-CDMA) intra or inter frequency handover according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

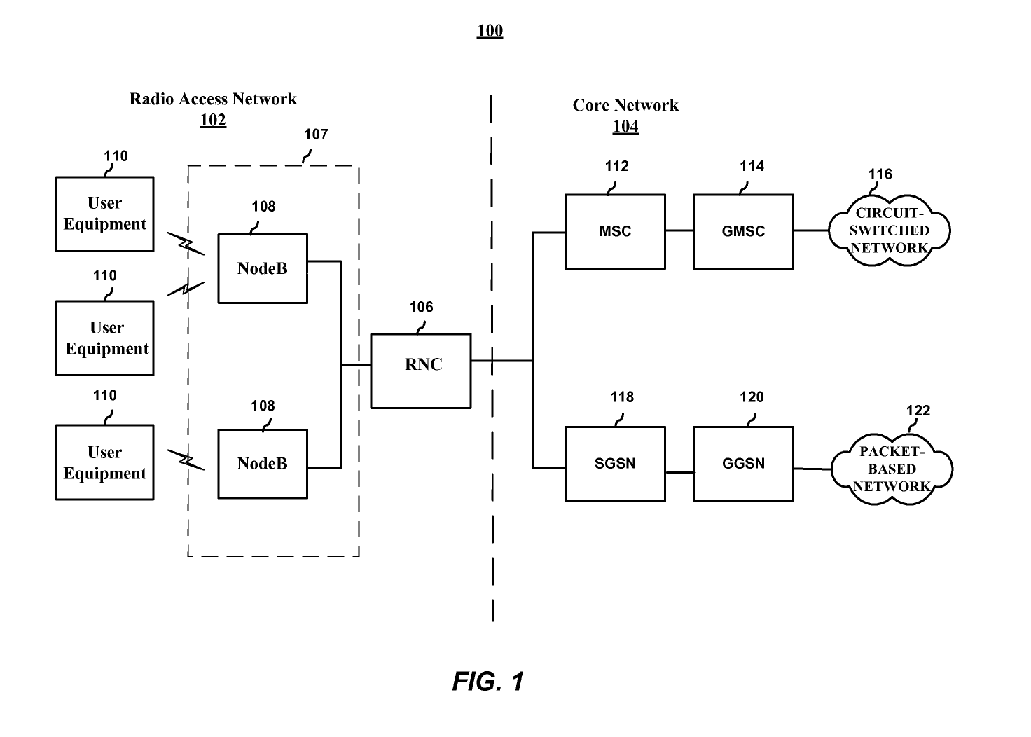

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

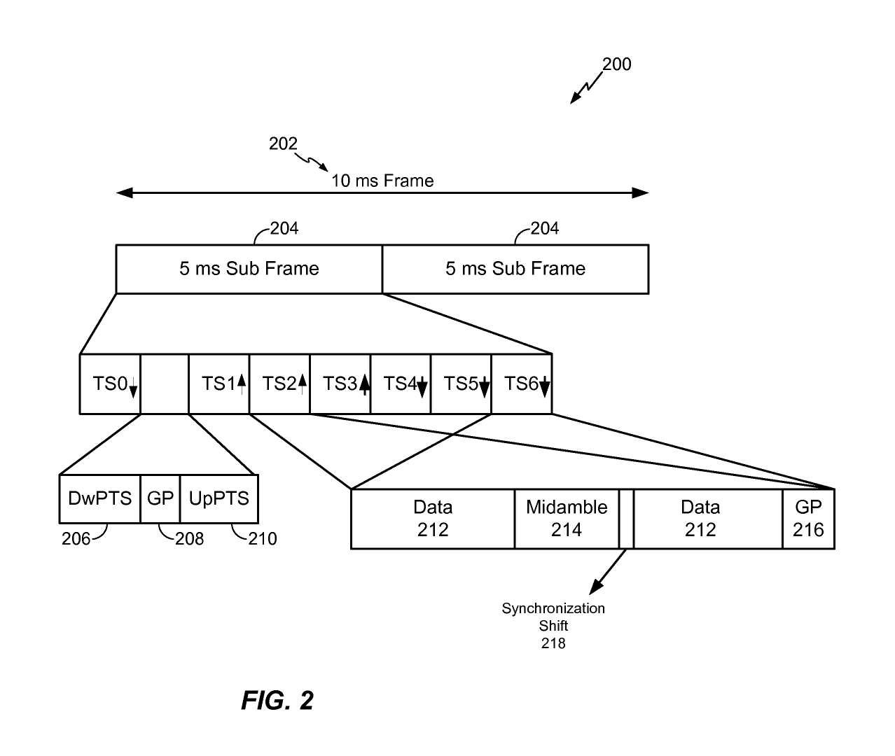

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

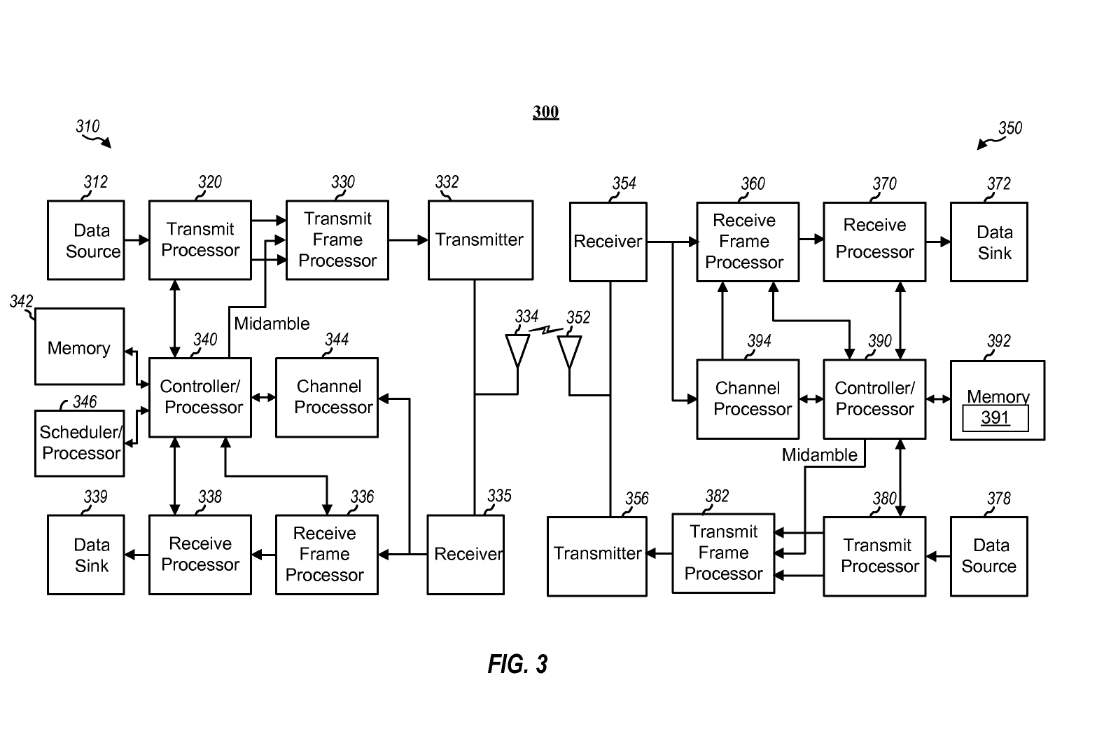

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store inter radio access technology measurement module 391 which, when executed by the controller/processor 390, configures the UE 350 for performing IRAT measurement according to aspects of the present disclosure. A scheduler/processor 346 at the node B 310 may be used to allocate resources to the UEs and schedule downlink and/or uplink transmissions for the UEs.

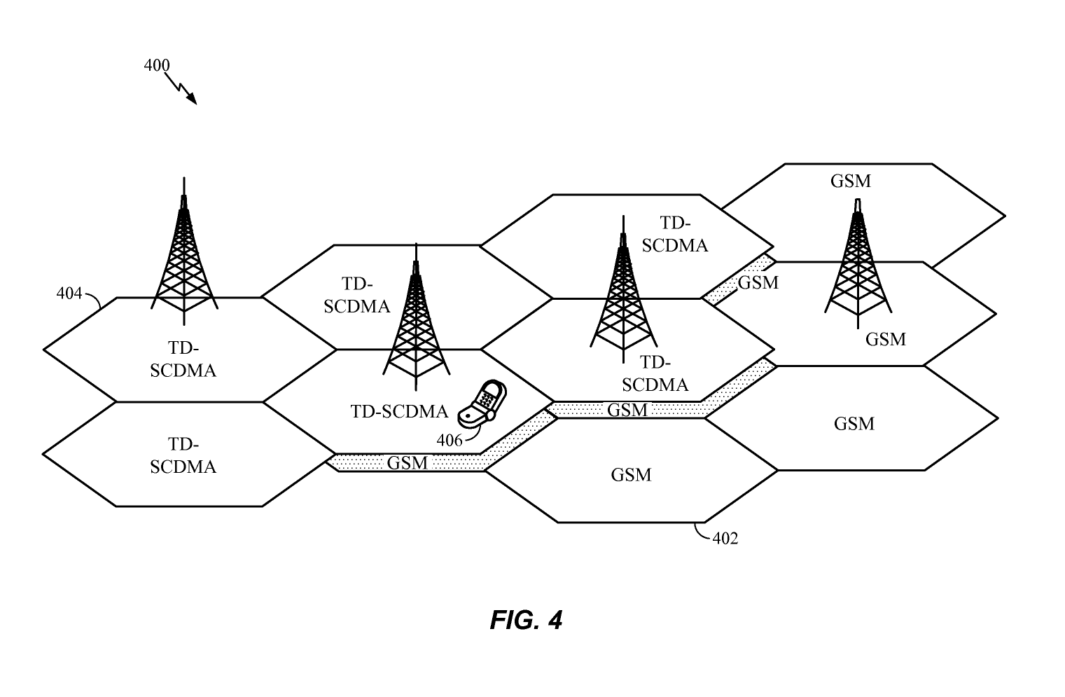

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402 or a different TD-SCDMA cell 404. The movement of the UE 406 may specify a handover or a cell reselection.

Handover or cell reselection may be performed when the UE moves from a coverage area of a serving radio access technology cell (e.g., serving TD-SCDMA cell) to the coverage area of a target RAT neighbor cell (e.g., target TD-SCDMA cell), or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with the serving TD-SCDMA cell, a UE may be specified to perform inter-radio access technology (IRAT) measurements of a neighbor cell, such as GSM cell. For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

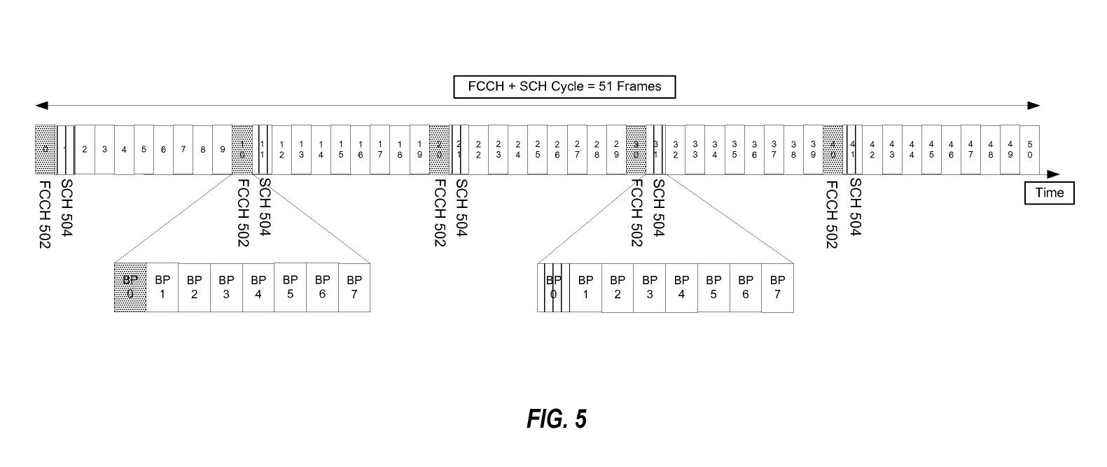

FIG. 5 is a block diagram illustrating a GSM frame cycle. The GSM frame cycle for the frequency correction channel (FCCH) 502 and synchronization channel (SCH) 504 consists of 51 frames, each of 8 burst periods (BPs). The FCCH 502 is in the first burst period (or BP 0) of frame 0, 10, 20, 30, 40, and the SCH 504 is in the first burst period of frame 1, 11, 21, 31, 41. A single burst period is 15/26 ms and a single frame is 120/26 ms. As shown in FIG. 5, the FCCH period is 10 frames (46.15 ms) or 11 frames (51.77 ms). Also as shown, the SCH period is 10 frames or 11 frames.

Inter Radio Access Technology (IRAT) Measurement During TD-SCDMA Handover

Current TD-SCDMA handover specification and implementations halt IRAT measurements associated with a serving TD-SCDMA cell during handover from the serving TD-SCDMA cell to a closely-located target TD-SCDMA cell. The serving TD-SCDMA cell and the target TD-SCDMA cell are closely-located such that common GSM neighbor cells are shared between the serving TD-SCDMA cell and the target TD-SCDMA cell. The IRAT measurements of the common GSM neighbor cells implemented prior to the handover (i.e., in accordance with the serving TD-SCDMA cell), however, are not carried over or used after handover to the target TD-SCDMA cell. Thus, after handover, a UE may be subject to performing full IRAT measurements of all common GSM neighbor cells, rather than incorporating aspects of the previous IRAT measurements. Performing full IRAT measurements instead of reusing aspects of stored IRAT measurements of common GSM neighbor cells, results in wasted UE resources and delaying IRAT measurement report, which may result in IRAT handover failure. Thus, there is a desire to improve handover performance of a UE by improving the application and reuse of IRAT measurements.

Aspects of the present disclosure improve IRAT handover performance by reusing stored IRAT measurement information associated with common GSM neighbor cells when a UE moves from a serving TD-SCDMA cell to a target TD-SCDMA neighbor cell. The IRAT measurement information associated with the serving TD-SCDMA cell may be stored in a memory of the UE prior to handover or reselection to the target TD-SCDMA cell. As noted, conventional implementations may clear or ignore the saved IRAT measurement information. Reusing the stored IRAT measurement information of the common GSM neighbor cells reduces the allocation of wasted resources. Thus, the UE can use more resources to perform complete IRAT measurements only for uncommon or new GSM neighbor cells associated with the target TD-SCDMA cell.

Handover of a UE from the serving TD-SCDMA cell to the target TD-SCDMA cell may occur when the serving TD-SCDMA cell received signal code power (RSCP) is below a target TD-SCDMA cell RSCP by a defined margin. The UE may send intra or inter frequency measurements prior to the handover. The serving TD-SCDMA cell may then trigger a handover of the UE to the target TD-SCDMA cell based on the measurement report.

In present TD-SCDMA communications, the UE uses transmission gaps or idle time slots to perform IRAT measurements of GSM neighbor cells, such as GSM FCCH tone detection and SCH BSIC confirmation and reconfirmation. Because the available TD-SCDMA time slots are limited (for example, only two or three continuous time slots are typically available in a TD-SCDMA subframe), the UE has limited time to measure the GSM neighbor cells and/or may not complete a full measurement during the available time slots. For example, even when the UE has sufficient idle time slots, the UE may continue to tune to different GSM frequencies and perform FCCH tone detection. In this scenario, the FCCH tone detection associated with each GSM cell wastes the UE battery and communication resources. Consequently, IRAT measurement may be delayed, resulting in IRAT handover failure.

Various aspects of the present disclosure are directed to efficient use of transmission gaps, which correspond to idle time slots, scheduled for IRAT measurement to improve handover performance when a UE moves from a serving TD-SCDMA cell to a target TD-SCDMA cell.

To facilitate IRAT measurements of the GSM neighbor cells, GSM neighbor information may be broadcast in a TD-SCDMA system information block 11 (SIB-11) for idle mode and provided in a measurement control message (MCM) during traffic. The GSM neighbor information may include a list of GSM neighbor cells camped around or in close proximity to the serving/target TD-SCDMA cell.

In some conventional communication standards, e.g., China Communications Standards Association (CCSA), when the UE is experiencing poor TD-SCDMA coverage, the UE may send the measurement report with a ranked list of available cells, (e.g., ranked GSM neighbor cells) to TD-SCDMA network. A top ranked target cell (e.g., top ranked TD-SCDMA cell) with the strongest RSSI in the ranked list may be selected or targeted for handover. Typically, the ranked list may only include GSM cells that meet a signal strength (e.g., RSSI) threshold. For example, the ranked list may represent a GSM RSSI order of top ranked GSM cells that meet a threshold requirement. In some implementations, however, the ranked list may include a predetermined number of ranked cells.

The list of GSM neighbor cells associated with the serving TD-SCDMA cell, however, may have a large subset of GSM neighbor cells in common with any bordering or closely-located target TD-SCDMA cells. Thus, when the UE reselects or hands over to a closely-located target TD-SCDMA cell that is in the coverage boundary for the UE, some of the GSM neighbor cells associated with the target TD-SCDMA cell and the serving TD-SCDMA cell are the same. As a result, some aspects of the IRAT measurements before and after handover are the same with respect to the common GSM neighbor cells.

According to the conventional communication standards, intra or inter frequency handover of a UE from the serving TD-SCDMA cell to the target TD-SCDMA cell may be indicated by a change in a cell parameter identification (CPID) or cell ID. For example, the CPID changes from a CPID representing the serving TD-SCDMA cell to a CPID representing the target TD-SCDMA cell. In accordance with the handover to the target TD-SCDMA cell, the base station can add new GSM neighbor cells associated with the target TD-SCDMA cell in addition to the common GSM neighbor cells. The new GSM neighbor cells may be different from the GSM neighbor cells associated with the serving TD-SCDMA cell.

According to the conventional communication standards, the UE stops performing IRAT measurements associated with the serving TD-SCDMA cell during/after a TD-SCDMA intra or inter frequency handover. For example, the UE halts scheduling GSM RSSI measurements and BSIC confirmation and reconfirmation procedures. Prior to halting IRAT measurements, the UE records IRAT measurement information associated with the serving TD-SCDMA cell. For example, the UE records GSM RSSI strength order, the ranked list of GSM neighbor cells and GSM synchronization channel (SCH) timing relative to the UE internal timer. The recorded IRAT measurement information may include measurement information of the common GSM neighbor cells. The IRAT measurements resume when the UE receives an measurement control message from the target TD-SCDMA cell including the GSM neighbor list of common GSM neighbor cells and new GSM neighbor cells.

According to some aspects of the present disclosure, the stored IRAT measurement information may be used to facilitate IRAT measurements after handover to the target TD-SCDMA cell. In one aspect, the UE may incorporate aspects of the stored IRAT measurement information to schedule IRAT measurements of the common GSM neighbor cells after the handover. For example, the UE may use the recorded GSM RSSI order to define a current GSM RSSI measurement order for the target TD-SCDMA cell. Further, the UE may use previously recorded GSM SCH timing relative to UE internal timer to schedule transmission gaps for FCCH tone detection and SCH BSIC procedure of the common GSM neighbor cells, instead of performing a fully blind FCCH tone detection and SCH BSIC.

The use of recorded IRAT measurement information of common GSM neighbor cells for IRAT measurements after handover improves handover performance of the UE. Further, the limited transmission gaps for scheduling IRAT measurements are used efficiently by only performing complete measurements on cells for which there is no stored measurement information.

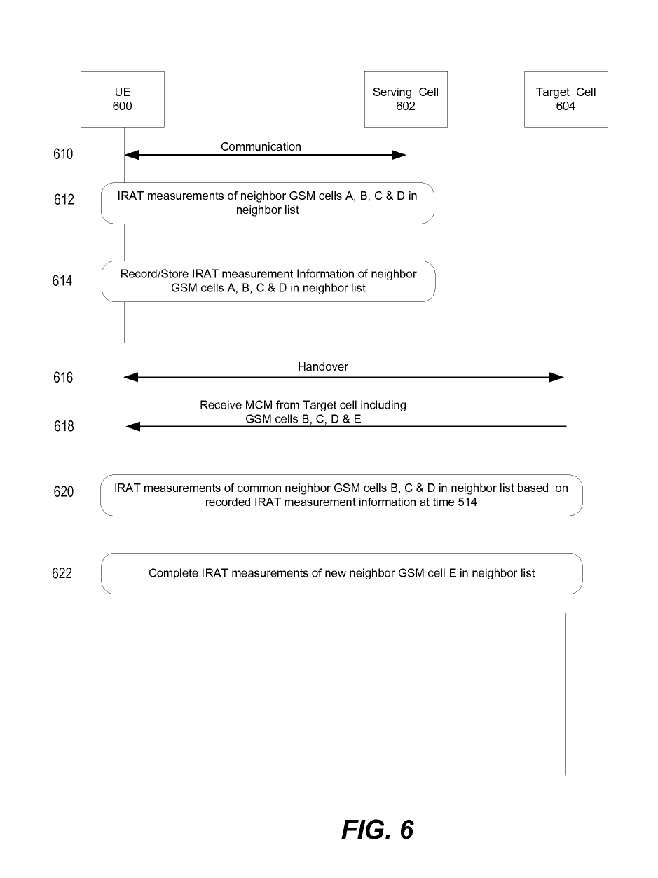

FIG. 6 illustrates a call flow implementation for handing over a UE 600 from a serving cell 602, (such as serving TD-SCDMA cell) to a closely-located target cell 604 (such as target TD-SCDMA cell 604) according to some aspects of the present disclosure. The UE 600 is engaged in an ongoing communication with a serving cell 602 at a time 610. As part of the communication at time 610, the serving cell 602 performs IRAT measurements at time 612 for handover to a target cell 604. The IRAT measurements may include measurements of neighbor GSM cells, A, B, C and D included in a neighbor list received from the serving cell 602. As part of the IRAT measurements, the UE determines whether it has sufficient idle time slots (or transmission gaps) for scheduling a fully blind FCCH tone detection and to perform BSIC confirm/reconfirm procedures. In addition, the UE measures GSM RSSI, performs the FCCH tone detection and performs SCH BSIC procedure for the GSM neighbor cells (A, B, C and D).

At time 614, the UE records IRAT measurement information associated with the serving cell 602. As noted, the IRAT measurement information may include GSM RSSI strength order and GSM SCH timing relative to the UE internal timer. The recorded IRAT measurement information may represent IRAT measurements of the GSM neighbor cells, A, B, C and D included in a neighbor list received from the serving cell 602. At time 616, the UE may perform intra or inter frequency handover from the serving cell 602 to the target cell 604. A change in cell parameter identification (CPID) indicating a handover from the serving cell 602 to the target cells 604 may cause the UE 600 to stop performance of IRAT measurements associated with the serving cell 602 in accordance with some communications specifications (e.g., China Communications Standards Association).

As a result of being closely-located, the GSM neighbor cells in the neighbor list associated with the serving cell 602 may have some commonality with the GSM neighbor cells associated with the target cell 604. In this case, the serving cell 602 and the target cell 604 share GSM neighbor cells B, C and D.

To facilitate IRAT measurements of the GSM neighbor cells after handover or reselection of the target cell 604 (i.e., the current serving TD-SCDMA cell), GSM neighbor information may be informed by the target cell 604 in a MCM during traffic. As noted, the GSM neighbor information may include a list of GSM neighbor cells around or in close proximity to the target cell 604. The MCM sent from the target cell 604 may be received by the UE at time 618.

At time 620, the UE performs IRAT measurements of the common GSM neighbor cells using aspects of the stored IRAT measurement information to speed-up the current IRAT measurement procedure. Thus, the UE uses previously recorded IRAT measurement information (at time 614) of common GSM neighbor cells (i.e., cells B, C and D) to avoid performing a full IRAT measurement of the common GSM neighbor cells. For example, the UE may use the previously recorded GSM RSSI order of the common GSM neighbor cells (i.e., ranked list of GSM neighbor cells) to define a current GSM RSSI measurement order, rather than performing a complete IRAT measurement of each GSM neighbor cell associated with the target cell 604. Further, the UE may use previously recorded GSM SCH timing relative to a UE internal timer to schedule transmission gaps for FCCH tone detection and SCH BSIC procedure of the common GSM neighbor cells (B, C and D), instead of a fully blind FCCH tone detection and SCH BSIC.

At time 622, the UE performs a complete IRAT measurement of the new GSM neighbor cell E. For example, the UE performs a fully blind FCCH tone detection and and SCH BSIC procedure because there are no previously recorded measurement information of the cell E, which is not commonly shared between the serving and target TD-SCDMA cells.

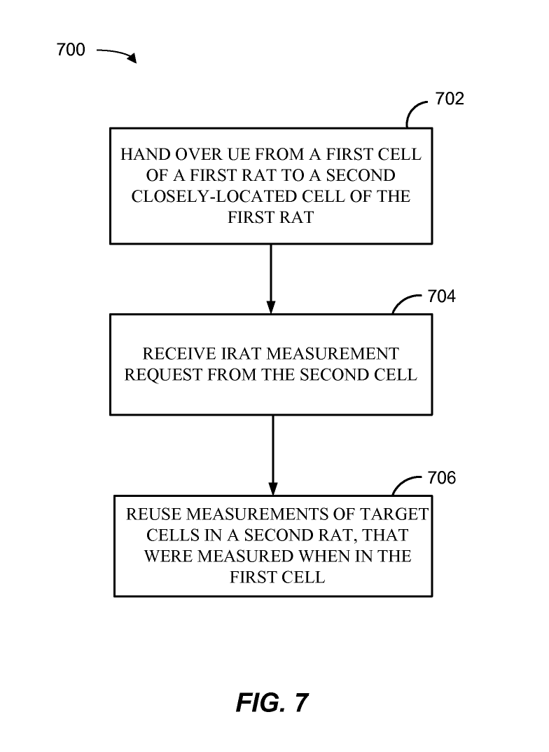

FIG. 7 shows a wireless communication method 700 according to one aspect of the disclosure. A UE may be handed over from a first cell of a first radio access technology (RAT) to a second cell of the first RAT, in which the first and second cells are closely-located, as shown in block 702. The UE also receives an inter-radio access technology (IRAT) measurement request from the second cell, as shown in block 704. Further, the UE reuses measurements of target cells in a second RAT that were measured when in the first cell, as shown in block 706.

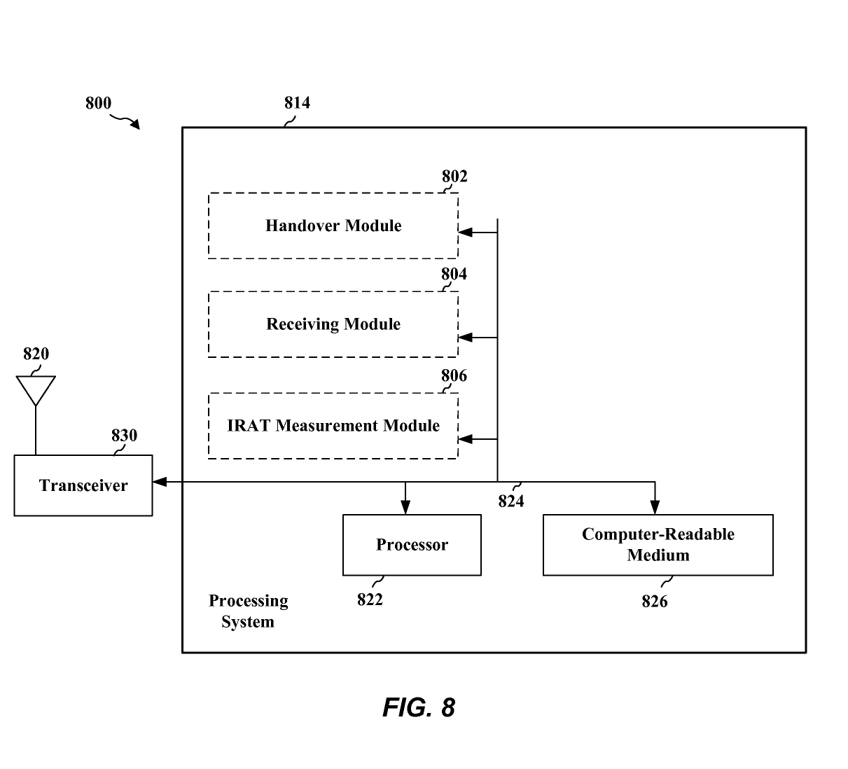

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the modules 802, 804, 806 and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a handover module 802 for handing over from a first cell of a first RAT to a second closely-located cell of the first RAT. The processing system 814 includes a receiving module 804 for receiving an IRAT measurement request from the second cell. The processing system 814 includes an IRAT measurement module 806 for reusing measurements of target cells in a second RAT that were measured when in the first cell. The modules may be software modules running in the processor 822, resident/stored in the computer readable medium 826, one or more hardware modules coupled to the processor 822, or some combination thereof. The processing system 814 may be a component of the UE 350 and may include the memory 392, and/or the controller/processor 390.

In one configuration, an apparatus such as a UE is configured for wireless communication including means for handing over from a first cell of a first RAT to a second closely-located cell of the first RAT. In one aspect, the above means may be the channel processor 394, the receive frame processor 360, the receive processor 370, the transmitter 356, the transmit frame processor 382, the transmit processor 380, the controller/processor 390, the memory 392, the IRAT measurement module 391, handover module 802, and/or the processing system 814 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for receiving an IRAT measurement request from the second cell. In one aspect, the above means may be the channel processor 394, the receive frame processor 360, the receive processor 370, the receiver 354, the controller/processor 390, the memory 392, the receiving module 804, the antenna 820, the transceiver 830, and/or the processing system 814 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for reusing measurements of target cells in a second RAT that were measured when in the first cell. In one aspect, the above means may be the channel processor 394, the receive frame processor 360, the receive processor 370, the transmitter 356, the transmit frame processor 382, the transmit processor 380, the controller/processor 390, the memory 392, the IRAT measurement module 391, the IRAT measurement module 806, and/or the processing system 814 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
handing over from a first cell of a first radio access technology (RAT) to a second cell of the first RAT, the first and second cells being closely-located;
receiving an inter-radio access technology (IRAT) measurement request from the second cell; and
reusing measurements of target cells in a second RAT that were measured when in the first cell.

2. The method of claim 1, in which the measurements comprise timing and signal strength measurements.

3. The method of claim 2, further comprising, performing signal strength measurements of new cells in the second RAT and sorting signal strength measurements of the new cells and signal strength measurements of target cells that were measured when in the first cell.

4. The method of claim 3, further comprising performing frequency correction channel (FCCH) tone detection and synchronization channel (SCH) base station identification confirmation (BSIC) and reconfirmation in accordance with the sorting.

5. The method of claim 3, in which a predetermined number of cells are selected for a ranked list based on the sorting.

6. The method of claim 2, further comprising reusing timing information of target cells that were measured when in the first cell to schedule first RAT idle time slots to perform a frequency correction channel (FCCH) tone detection and synchronization channel (SCH) base station identification confirmation (BSIC) and reconfirmation.

7. The method of claim 2, further comprising performing blind frequency correction channel (FCCH) tone detection for new cells in the second RAT.

8. The method of claim 1, in which the first cell has a cell identifier different from a cell identifier of the second cell.

9. An apparatus for wireless communication, comprising:
means for handing over from a first cell of a first radio access technology (RAT) to a second cell of the first RAT, the first and second cells being closely-located;
means for receiving an inter-radio access technology (IRAT) measurement request from the second cell; and
means for reusing measurements of target cells in a second RAT that were measured when in the first cell.

10. The apparatus of claim 9, in which the reusing means further comprises means for reusing timing information of target cells that were measured when in the first cell to schedule first RAT idle time slots to perform a frequency correction channel (FCCH) tone detection and synchronization channel (SCH) base station identification confirmation (BSIC) and reconfirmation.

11. An apparatus for wireless communication, comprising:
a memory; and
at least one processor coupled to the memory and configured:
to hand over from a first cell of a first radio access technology (RAT) to a second cell of the first RAT, the first and second cells being closely-located;
to receive an inter-radio access technology (IRAT) measurement request from the second cell; and
to reuse measurements of target cells in a second RAT that were measured when in the first cell.

12. The apparatus of claim 11, in which the measurements comprise timing and signal strength measurements.

13. The apparatus of claim 12, in which the at least one processor is further configured to perform signal strength measurements of new cells in the second RAT and to sort signal strength measurements of the new cells and signal strength measurements of target cells that were measured when in the first cell.

14. The apparatus of claim 13, in which the at least one processor is further configured to perform by performing frequency correction channel (FCCH) tone detection and synchronization channel (SCH) base station identification confirmation (BSIC) and reconfirmation in accordance with the sorting.

15. The apparatus of claim 13, in which a predetermined number of cells are selected for a ranked list based on the sorting.

16. The apparatus of claim 12, in which the at least one processor is further configured to reuse by reusing timing information of target cells that were measured when in the first cell to schedule first RAT idle time slots to perform a frequency correction channel (FCCH) tone detection and synchronization channel (SCH) base station identification confirmation (BSIC) and reconfirmation.

17. The apparatus of claim 12, in which the at least one processor is further configured to perform blind frequency correction channel (FCCH) tone detection for new cells in the second RAT.

18. The apparatus of claim 11, in which the first cell has a cell identifier different from a cell identifier of the second cell.

19. A computer program product for wireless communications in a wireless network, comprising:
a computer-readable medium having non-transitory program code recorded thereon, the program code comprising:
program code to hand over from a first cell of a first radio access technology (RAT) to a second cell of the first RAT, the first and second cells being closely-located;
program code to receive an inter-radio access technology (IRAT) measurement request from the second cell; and
program code to reuse measurements of target cells in a second RAT that were measured when in the first cell.

20. The computer program product of claim 19, in which the program code further comprises code to reuse by reusing timing information of target cells that were measured when in the first cell to schedule first RAT idle time slots to perform a frequency correction channel (FCCH) tone detection and synchronization channel (SCH) base station identification confirmation (BSIC) and reconfirmation.
